(19) United States
(12) Patent Application Publication
(10) Pub. No.: US 2017/0308549 A1
(43) Pub. Date: Oct. 26, 2017

(54) GEOGRAPHICAL INFORMATION SYSTEM AND METHOD FOR SEARCHING LAND PARCELS

(71) Applicant: OneMap Pty Ltd, Richmond (Melbourne), Victoria (AU)

(72) Inventors: Aaron Jeremy Sims, Richmond (Melbourne), Victoria (AU); Michael William Natoli, Richmond (Melbourne), Victoria (AU); Michael John Cushen, Richmond (Melbourne), Victoria (AU)

(21) Appl. No.: 15/517,830

(22) PCT Filed: Oct. 8, 2015
(86) PCT No.: PCT/AU2015/050612

§ 371 Date: Apr. 7, 2017

(30) Foreign Application Priority Data
Oct. 10, 2014 (AU) 2014904048

(51) Int. Cl. G06F 17/30; G06Q 50/16

(52) U.S. Cl. CPC G06F 17/30241; G06Q 50/163; G06Q 50/167

(57) ABSTRACT

A system including: a computer system configured to: access geographical information system (GIS) data, including land-parcel data representing land-parcel coordinates that define a plurality of land parcels, and publicly accessible destination data representing coordinates of publicly accessible destinations, and/or publicly accessible region data representing one or more regions with associated features, and process the GIS data to generate processed GIS data representing attributes of each land parcel associated with: distances between each land parcel and the publicly accessible destinations; and/or features of the regions that overlap with the land-parcel coordinates; and at least one server configured to: receive request data representing query criteria for selecting ones of the land parcels; filter the processed GIS data to select ones of the land parcels with distances and/or features matching the query criteria; and generate response data representing the selected ones of the land parcels.

### TECHNICAL FIELD

The present invention generally relates to geographical information systems and methods for searching land parcels, e.g., to identify appropriate land parcels for property development.

### BACKGROUND

Traditionally, in order to identify appropriate sites for potential property development, property developers have identified sites by visual inspection of the sites (e.g., by visiting sites), and inspection of maps (e.g., commercially available street maps). Once potential sites were identified, the property developers would then need to request relevant records from governments and authorities (e.g., planning agencies), to determine information of interest, e.g., recent sale prices, land sizes, zoning requirements, etc.

Although it has recently become possible to view maps on real-estate websites that provide additional property information on the maps (e.g., recent prices, number of bathrooms, etc.), such maps are designed for individual property purchases, and thus are not sufficiently fast, efficient, flexible and relevant for some property developers.

Currently, to gain a better understanding of available properties across large areas, property developers may engage professional urban planning consultants to prepare reports using professional analysis of large data sets, using complicated geographical information system (GIS) tools, based on predefined criteria (e.g., a minimum lot size) from the developers. This is a relatively slow and expensive process, and is undesirable if the developers wish to adjust their criteria and access new reports; however, existing GIS tools are too complicated, and the processing required takes too long, for convenient and flexible use by property developers.

It is desired to address or ameliorate one or more disadvantages or limitations associated with the prior art, or to at least provide a useful alternative.

### SUMMARY

In accordance with the present invention, there is provided a system including:
a computer system configured to:
   access geographical information system (GIS) data, including land-parcel data defining a plurality of land parcels, and destination data representing locations of publicly accessible destinations, and
   process the GIS data to generate proximity data by determining distances between each land parcel and the publicly accessible destinations, and representing the determined distances by the proximity data; and
at least one server configured to:
   receive request data representing one or more criteria including a requested distance for selecting ones of the land parcels, and
   generate response data representing ones of the land parcels with ones of the determined distances in the proximity data matching the criteria.

The present invention also provides a method, including the steps of:
accessing geographical information system (GIS) data, including land-parcel data defining a plurality of land parcels, and destination data representing locations of publicly accessible destinations;
processing the GIS data to generate proximity data by determining distances between each land parcel and the publicly accessible destinations, and representing the determined distances by the proximity data;
receiving request data representing one or more criteria including a requested distance for selecting ones of the land parcels; and
generating response data representing ones of the land parcels with ones of the determined distances in the proximity data matching the criteria.

The present invention also provides a system including:
a computer system configured to:
   access geographical information system (GIS) data, including land-parcel data representing land-parcel coordinates that define a plurality of land parcels, and publicly accessible destination data representing coordinates of publicly accessible destinations, and/or publicly accessible region data representing one or more regions with associated features, and
   process the GIS data to generate processed GIS data representing attributes of each land parcel associated with: distances between each land parcel and the publicly accessible destinations; and/or features of the regions that overlap with the land-parcel coordinates; and
at least one server configured to:
   receive request data representing query criteria for selecting ones of the land parcels;
   filter the processed GIS data to select ones of the land parcels with distances and/or features matching the query criteria; and
   generate response data representing the selected ones of the land parcels.

The present invention also provides a method including:
accessing geographical information system (GIS) data, including land-parcel data representing land-parcel coordinates that define a plurality of land parcels, and publicly accessible destination data representing coordinates of publicly accessible destinations, and/or publicly accessible region data representing one or more regions with associated features;
processing the GIS data to generate processed GIS data representing attributes of each land parcel associated with: distances between each land parcel and the publicly accessible destinations; and/or features of the regions that overlap with the land-parcel coordinates;
receiving request data representing query criteria for selecting ones of the land parcels;
filtering the processed GIS data to select ones of the land parcels with distances and/or features matching the query criteria; and
generating response data representing the selected ones of the land parcels.

The present invention also provides a system including:
at least one client configured to generate a data query representing criteria for selecting land parcels based on their attributes, wherein client is configured to select a region identifier for the data query from a plurality of region identifiers based on a displayed map area of the client overlapping a sub-region associated with the selected region identifier; or
at least one server configured to receive a data query representing criteria for selecting land parcels based on their attributes, wherein server is configured to determine a data set for the land parcels by matching a region identifier of the data query with one of a plurality of region identifiers associated with respective data sets of the land parcels.

The present invention also provides a method including:
generating a data query representing criteria for selecting land parcels based on their attributes, including selecting a region identifier for the data query from a plurality of region identifiers based on a displayed map area of the client overlapping a sub-region associated with the selected region identifier; or
receiving a data query representing criteria for selecting land parcels based on their attributes, including determining a data set for the land parcels by matching a region identifier of the data query with one of a plurality of region identifiers associated with respective data sets of the land parcels.

The present invention also provides a system including:
a computer system configured to:
   access geographical information system (GIS) data, including land-parcel data defining geometries of a plurality of land parcels, and
   process the GIS data to record which of the land parcels has a equator-facing back yard by comparing a central point of each geometry with a latitude value on or towards a boundary of the geometry for geometries with north-south orientations; and
at least one server configured to:
   receive request data representing a criterion for an equator-facing back yard for selecting ones of the land parcels, and
   generate response data representing the ones of the land parcels with recorded equator-facing back yards.

The present invention also provides a method including:
accessing geographical information system (GIS) data, including land-parcel data defining geometries of a plurality of land parcels;
processing the GIS data to record which of the land parcels has a equator-facing back yard by comparing a central point of each geometry with a latitude value on or towards a boundary of the geometry for geometries with north-south orientations;
   receiving request data representing a criterion for an equator-facing back yard for selecting ones of the land parcels; and
   generating response data representing the ones of the land parcels with recorded equator-facing back yards.

The present invention also provides computer-readable storage with machine-readable instructions for controlling one or more computer processors to perform the above methods.

### BRIEF DESCRIPTION OF THE DRAWINGS

Preferred embodiments of the present invention are hereinafter described, by way of non-limiting example only, with reference to the accompanying drawings, in which:

FIG. 1 is a block diagram of a system;

FIG. 2 is a block diagram of computational modules of the system;

FIG. 3 is a flowchart of a pre-processing method performed by the system;

FIG. 4 is a flow diagram of a distance-determination method performed by the system;

FIG. 5 is a flowchart of a planning-control-determination method performed by the system;

FIG. 6 is a flowchart of an area-determination method performed by the system;

FIG. 7A is an example map showing an identified land parcel and two train access points;

FIG. 7B is an example map showing an on-street distance between the identified land parcel and a nearest one of the train access points;

FIG. 7C is a map showing the identified land parcel overlapping with a predefined zone area;

FIGS. 8A, 8B and 8C are wire-frame diagrams of a user interface of the system; and

FIG. 9 is a diagram of a client map display relative to sub-regions of land parcels represented in the system.

### DETAILED DESCRIPTION

### Overview

Described herein is a system and a method that can enable a user (e.g., a property developer) to search for land parcels (also referred to as “properties”) based on relevant selection criteria, selected by the user, and to display the search results comprising the selected land parcels on a map in near real time, all with a user-friendly user interface (UI) accessible in a web browser over the internet. The selected land parcels meeting the criteria may be referred to as “search output”. The user can control and modify the selection criteria with the user interface, and the modified selection criteria can be used to generate a new set of selected land parcels for display in near real time. The system and method pre-process information from a plurality of data sources to provide processed data representing the land parcels (based on land parcel identifiers), in association with values of the potential search criteria for each land parcel, on an internet server system. On receiving user input from an internet client system, the system and method can rapidly select or filter the relevant land parcels by comparing the search criteria values to the values in the processed data. The land parcels may be referred to as “cadastral lots” if they are defined by coordinates specified in cadastral data, made accessible by State Governments.

The system includes a GIS Server and an application server. The system may be referred to as a tool. The criteria can include distance values representing on-street distances between the land parcels and predefined locations of publicly accessible destinations (which may be facilities). The distance from the land parcel may be determined based on a coordinate in the land parcel, which may be a centroid, or a street-frontage point. The pre-defined locations may include public transport stops, or public destination access points, defined by coordinates. The distance values may be referred to as “proximities”, “proximity values” or “accessibility values”. The distance values can be valuable in determining how quickly a person can travel (by foot, bike and/or car) from the land parcel to the destination, and/or back.

The system may provide user authentication and encryption for an authenticated user, and separate GIS authentication and encryption between the application server and the GIS server. The separate authentication methods allow the authorised users to access the application server without accessing the processed GIS data.

By making the processed data accessible to the application server, the searching performed by the user can be rapid and flexible. The processed data may include, for each processed land parcel, information relating to accessibility distances, planning controls, land features, and at least one pre-calculated weighted accessibility score. The system and method provide a pre-processing method that accesses published data sources and pre-processes raw GIS data in preparation for serving the processed data to the user.

When using the system and the method, the user may rapidly filter out irrelevant land parcels from a very large dataset, which may represent an entire municipality or local government area, and quickly adjust the values of the search criteria to find potential development sites and to view them on a map in near real time over the internet. There may be as many at 2 million separate searchable land parcels, with respective accessibility distances, planning controls, land features, etc., in the processed GIS data.

Compared to real-estate websites, for example, the system and method is not limited to properties that are advertised for sale, and allows for filtering to immediately select and display only relevant properties, based on different selectable criteria, on an enhanced map (e.g., colour-coded, and/or not displaying irrelevant properties). Furthermore, the criteria can be adjusted quickly by the user, and the enhanced map updated in near real time, allowing the user to gain a thorough understanding of the availability of sites having various levels of desirability (and thus which potential properties to consider for development).

### System

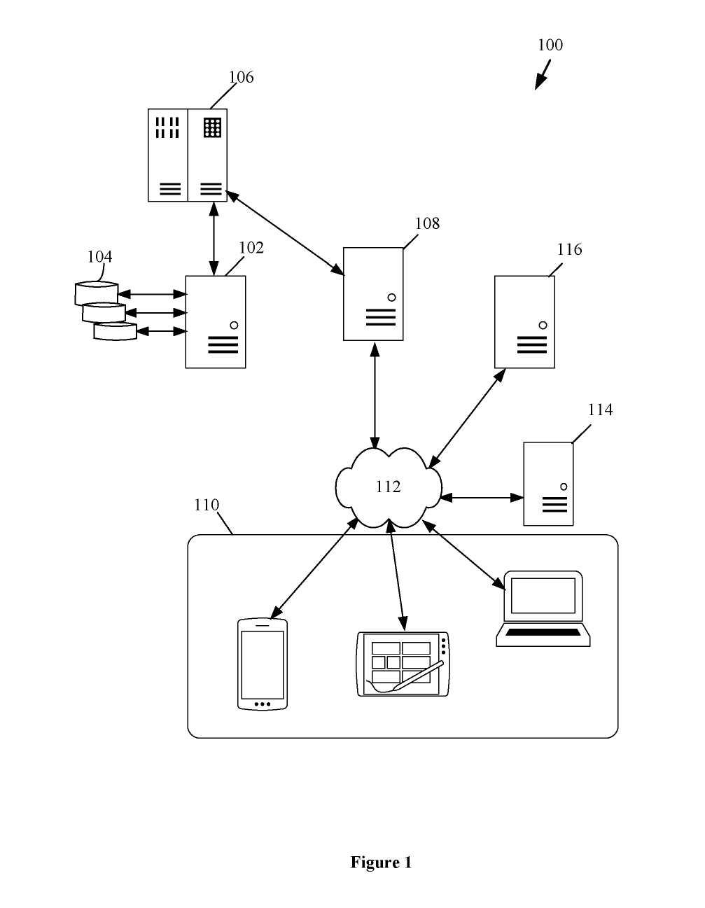

As shown in FIG. 1, a system 100 for searching land parcels includes a pre-processing computer system 102 that accesses published geographical information system (GIS) data (also referred to as “raw” GIS data) stored in accessible databases 104. The pre-processing computer system 102 may include commercially available computer hardware, and may communicate with the accessible databases 104 using commercially available connectors and communications protocols. The pre-processing computer system 102 imports and processes the raw GIS data to generate processed GIS data and imported GIS data for the system 100.

The system 100 includes a GIS server 106 that communicates with the pre-processing computer system 102 to receive the processed GIS data and the imported GIS data using commercially available connectors and communications protocols. The GIS server 106 may be hosted by a commercial provider and/or an open-source provider, e.g., CartoDB, and/or GeoServer. The GIS server 106 stores the processed GIS data and the imported data in one or more rapidly accessible data formats, which may include at least one GIS data table, a plurality of data tables, map-tile data and/or look-up tables. The processed GIS data and the imported GIS data may be converted by the processing computer system 102 into acceptable formats for the GIS server 106, which may be commercially available formats, including shape files (which may be referred to as “shapefiles”), which may conform to the ESRI format from the Environmental Systems Research Institute (ESRI). The shapefiles may be uploaded to the GIS server 106 using a standard user interface of the GIS server 106. Alternatively, the pre-processing system 102 may export the data directly in a geospatial data format (including a vector data format, which may be the Mapinfo TAB format) for the GIS server 106.

The system 100 includes an application server 108, in communication with the GIS server 106 using an internet protocol, to send data queries to the GIS server 106. The application server 108 may be an internet cloud-based web server platform, which may be provided by a commercial provider, such as Amazon's Elastic Compute Cloud (EC2).

The data queries from the application server 108 are sent to an application program interface (API) of the GIS server 106 with an access key or keys that identify the processed data in the GIS server 106, and may be used for authentication, security, encryption, and billing because the GIS server 106 may be part of an internet cloud server with more than one account. The API of the GIS server is provided by a GIS server module 220. The API key is a code provided by a tile proxy module 222 of the application server 108 when calling the API of the GIS server 106 to identify the tile proxy module 222. The key includes a string of semi-random characters used to authenticate requests coming from the tile proxy module 222 to the GIS server module 220. All server requests must therefore be accompanied by a valid API key to be recognized and accepted by the GIS server 106. Accordingly, the application server 108 is configured to receive the request data from the client, and to send the response data to the client; and the GIS server configured to communicate with the application server 108, to access the proximity data, and to generate the response data, and the application server 108 stores and uses the key data representing the access key to authenticate its communication with the GIS server. The client does not access or use the key data, and thus cannot access the data in the GIS server database 218 directly.

The system 100 includes one or more user devices 110 that communicate with the application server 108 through a data network 112, which may be the internet. The user devices 110 may include at least one smartphone, at least one tablet computer, at least one desktop computer, and at least one laptop computer. Each of the user devices provides a client for the application server 108. The client may be in the form of a web browser 230, which can include a commercially available web browser or a native application that processes data formatted for the World Wide Web and/or the internet. The client allows the user to log in and authenticate with quasi-unique user credentials (e.g., a user name and password) to the application server 108 through a hypertext mark up language (HTML) or web interface using standard protocols. The client provides a graphical user interface (UI) for the user to generate the data queries.

The user devices 110 send the data queries to the application server 108, which in turn generates corresponding data queries for the GIS server 106; however, the data queries from the user devices 110 do not include the access key or keys that are required to access the processed data in the GIS server 106. The separation of the user devices 110 from the access key data (which is stored in the application server 108) provides security of the processed data in the GIS server 106 from potential unauthorised access or copying by the user devices 110.

The system 100 includes a map provider 114 that serves map data to the user devices 110. An example map provider is the Google Maps server. The system 100 may include one or more public content delivery networks (CDNs) 116 that serve publicly available data libraries to the user devices. An example CDN is Amazon's CloudFront. Where identical copies of common libraries are hosted all over the world, these can be reused, and users are given the closest copy of the file. “jQuery” for example is used by a number of different sites, and it does not need to be reloaded every time a website using jQuery is loaded. Instead of using the CDN 116, or additionally, the application server 108 can download data representing some or all of the required libraries, compress the downloaded data, compile the downloaded data offline, and deliver this pre-compiled data to the client. The map provider 114 and the CDNs 116 communicate with the user devices 110 using standard internet protocols to provide the maps and libraries as required by the client.

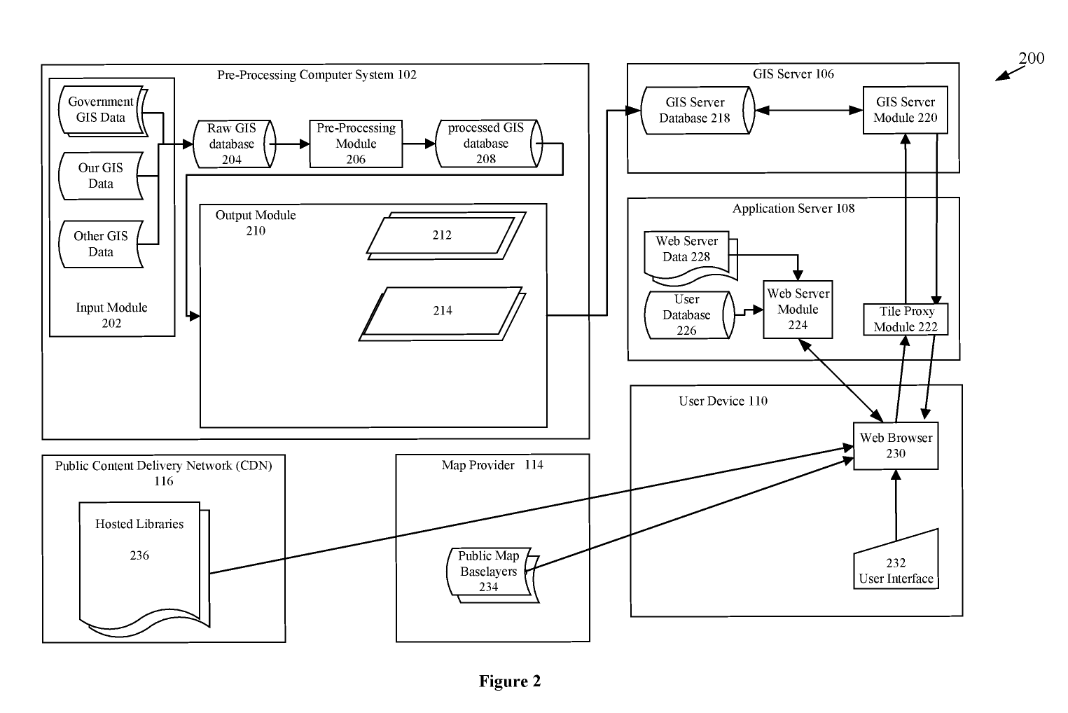

As shown in FIG. 2, the pre-processing computer system 102 includes an input module 202 that is configured to access and upload input data to the pre-processing computer system 102. The input module 202 includes a plurality of data connectors or input tools that can access, and authenticate (if necessary) with a plurality of data sources that contain information defining the publicly accessible destinations. The data connectors receive the raw data from various sources. The data connectors may allow automatic downloading of the raw data in existing formats. Alternatively, the raw data may be downloaded from the sources using existing website interfaces, and stored in existing formats, for uploading to—or opening by—the pre-processing computer system 102.

The raw data include raw land-parcel data, including:
a. land parcel map polygons representing geospatial coordinates (or “geometry”) of land parcels (e.g., Vicmap data source for Victoria, Australia);
b. real-estate market data representing identifiers and values or codes of properties for sale, and sold properties; and
c. street address data representing geospatial coordinates of street address of land parcels.

The raw data include raw region data representing regions or areas (including zones or municipal areas), defined by coordinates, polylines, or polygons, and one or more features of attributes of each area (including codes or values):
a. elevation data representing values of elevations of areas defined by geospatial coordinates, and details of contours;
b. topography data, including slope data representing slope analysis plans, including the steepnesses of the respective defined areas (regions);
c. flood data representing values or codes associated with potential flooding effects in respective defined areas (regions);
d. market region data representing identifiers and values of areas and real-estate prices or values in those areas (regions);
e. planning controls data (also referred to as “government planning data”) representing planning control codes and descriptions associated with areas (regions) defined by geospatial coordinates (which may include polygons defining the geometry, and attributes represented by characters, following standard protocols within each administrative area, such as a State), including planning zones, planning overlays, planning strategy zones, planning decision zones, and heritage overlays;
f. government boundaries data representing government and administrative boundaries, including state boundaries, council boundaries, and suburb boundaries; and
g. real estate government data representing statistical market prices (values) for the areas (regions), e.g., median suburb house price, median suburb apartment price, from the Australian Bureau of Statistics.

The raw data include raw publicly accessible destination data representing specific locations of the public destinations or facilities, including:
a. tram stop data representing geospatial coordinates of tram stops;
b. train stop data representing geospatial coordinates of train stops;
c. bus stop data representing geospatial coordinates of bus stops;
d. retail data representing geospatial coordinates of shops and shopping precincts;
e. open space data representing geospatial coordinates of open spaces;
f. educational facility data representing geospatial coordinates of schools, colleges, universities, etc.;
g. business district data representing geospatial coordinates of business districts; and
h. foreshore data representing water fronts (e.g., beaches, bays, river banks, etc.).

The raw data include raw street network data representing coordinates of a street network, including streets and laneways (including geometry in the form of lines and polylines), and street attributes in the form of integers representing different street classes (e.g., freeway, highway, major road).

The input module 202 combines the accessed GIS data into a raw GIS database 204 in the pre-processing computer system 102. The raw GIS data may be stored in a format suitable for the pre-processing module 206, and this may be a commercially available table format, e.g., the MapInfo table (TAB) format.

The input module 202 assigns quasi-unique identifiers (IDs) to the land parcels, areas, and destinations in the raw GIS data. These IDs can be referred to as “property IDs” or “Land Parcel IDs”. The IDs can be characters or codes. For raw GIS data in tables, where each type of imported data is in separate table (e.g., land parcels in one table, train stops in a different table, etc.), an ID can be assigned to each row of each table.

The input module 202 imports and processes some of the raw GIS data to generate the imported GIS data (also referred to as look-up data). The imported GIS data represent some of the information in the raw GIS data in suitable structures for use by the system 100. The imported data can represent look-up tables of schools (including school names associated with school IDs), look-up tables of supermarkets (including supermarket names associated with supermarket locations), geometries of zones in the whole region, and geometries of overlays in the whole region.

The pre-processing computer system 102 includes a pre-processing module 206 that processes the raw GIS data in the raw GIS database 204 to generate processed GIS data. The pre-processing module 206 stores the processed GIS data in a processed GIS database 208 in the pre-processing computer system 102, as described hereinafter. The pre-processing computer system 102 includes an output module 210 that generates output data for the GIS server 106 into formats compatible with the GIS server 106 (which may be the shapefiles): the pre-processing module 206 may generate geospatial data in the form of MapInfo Tables or MapInfo TAB files. The generated geospatial data may be converted by the output module 210 into output data (including the ESRI shapefiles) for uploading to the GIS server 106 using a data management interface of the GIS server 106. Alternatively, the generated geospatial data may be the output data, without any need for format conversion: thus, if the GIS server 106 can receive and process the generated geospatial data without conversion, the system 100 may not need the output module 210 for additional format conversion. The output data are transmitted to the GIS server 106 from the pre-processing computer system 102, and are stored in a GIS server database 218. The output data (which may be in the form of a plurality of shapefiles), and thus the stored GIS data, include the processed GIS data in the form of land-parcels data 212, representing the land-parcels and their respective processed attributes; and the layers data 214 representing the separate layers (based on portions of the imported GIS data).

The GIS server 106 includes the GIS server module 220 that provides the application program interface (API) for the GIS server 106, and thus receives the data queries and respective access keys from the application server 108, and returns the query results by applying the queries to the stored GIS data in the GIS server database 218. The GIS server 106 generates map tiles from the stored GIS data. If the land-parcels data are divided into a plurality of datasets corresponding to predefined sub-regions of the overall region, these regional datasets are stored separately in the stored GIS data (which may include using separate data structure instances, including tables) for each sub-region. The data queries include sub-region identifiers (Region Geometry IDs) corresponding to the sub-regions so that the GIS server 106 can select one of the regional datasets for each data query (based on the Region ID), and apply the query to only that dataset. This can reduce the time to process the query, particularly for large regions. For frequent data queries (including when the user device 110 zooms in, or out, or pans the view), processing the stored data for only one of the sub-regions can substantively improve performance (e.g., processing 600,000 land parcels rather than 3 million).

The application server 108 includes the tile proxy module 222 that receives the data queries from the user devices 110, appends or adds the access key data, and sends the data queries with the keys (forming “data requests”) to the GIS server module 220. The tile proxy module 222 also receives the query results from GIS server module 220 and serves them to the user device 110 (after removing details of the GIS access keys). The tile proxy module 222 may be implemented using a fast transactional server including a JavaScript-based runtime environment for server-side applications that is very efficient at processing requests and relaying data, e.g., Node.JS. The tile proxy module 222 may be implemented using computer-readable code that filters requests, then relays them to the GIS server 106 after adding the API Key, and then sends the responses to the user device 110.

The application server 108 includes a web server module 224 for communicating with the user device 110, providing authentication of the user details from the user device 110 (based on user data in a user database 226 of the application server 108). The application server 108 includes stored web-server data 228 in computer-readable memory of the application server 108. The web server module 224 may use a standard HTTP server. The user database 226 may store site and user data, including user names, passwords, user preferences, user settings, and history data representing favourite sites/locations and previous searches based on the previously generated data corresponding to that user identifier (ID). The web-server data may include scripts and files to support web protocols including personal home page (PHP), HTML, cascading style sheets (CSS), Java Script, and image files. The web-server data may include a Hypertext Transfer Protocol Secure (HTTPS) server, and Secure Socket Layer (SSL) certificates, for authentication between the browser 230 and the web server module 224 and the tile proxy module 222.

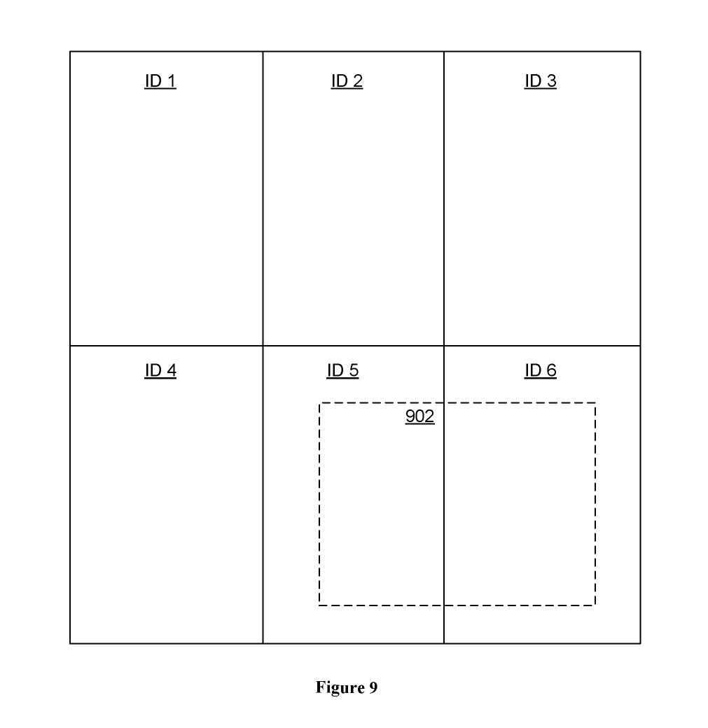

The user device 110 includes a client in a web browser 230 that provides a user interface 232 to the user. The web browser 230 receives user-input data from the user interface 232 to define the data queries that the web browser 230 sends to the tile proxy module 222. The web browser 230 communicates with the web server module 224 to send and receive data according to web protocols, including HTTPS and AJAX (Asynchronous JavaScript and XML), which allow web pages to updated data without reloading the entire page. This allows our users through the interface 232 to change sliders to update data queries, submit the queries to the tile proxy module 222, and then update the map when the new data tiles are ready. The client may be able to generate the data queries with a Region ID by comparing a current requested screen display area or screen extent (e.g., a rectangle, generated by the client) to local Region Geometries data (i.e., a set of geometry for each sub-region in a region represented by the land-parcels data 212, stored in or by the client), representing geometries of the available sub-regions in the stored GIS data with associated Region IDs, and thus match the requested display area with at least one of the sub-region geometries to select the appropriate at least one Region ID for the data queries. As shown in FIG. 9, in an example with six sub-regions (ID 1, ID 2, ID 3, ID 4, ID 5 and ID 6), the client can determine that the screen area 902 (also referred to as a “screen extent”) overlaps two of the sub-regions (ID 5 and ID 6), and thus the client can generate a data query specifying the Region IDs for these two sub-regions for use by the GIS server 106 when generating the query results.

The query results from the GIS server module 220, received by the tile proxy module 222, may be returned as text results, numerical values and map tiles. The map tiles may be generated on the fly by the GIS server 106 after processing the data query. The map tiles show the locations of parcels of land that fit the criteria selected in the data queries. The bitmap images are overlaid on the base map. Each map tile is a square bitmap graphic displayed in a grid arrangement to show a map: the standard is to use 256×256 pixel images. The map may be generated by the web browser 230 using public map data accessed from public base map layers 234 in the map provider 114. The base map layers 234, e.g., from Google Maps, include a plurality of map tiles, and various selectable layers (retrieved in query results from the GIS server 106, and generated using the layers data 214) are also in the form of map tiles, with transparency where there is no data to display so that the base map tiles are displayed. The text results and map tiles are processed by the web browser 230 to display them in the user interface 232 on a map. The public map base layers 234 may include satellite images, or street maps, selectable by the user interface 232, which are on the bottom layer of the map displayed, and available from commercial and open-source providers, e.g., Google map servers, Bing map servers, and Nokia map servers. The web browser 230 may generate the user interface 232 using standard hosted web libraries 236 accessed in the CDN 116, or accessed in the application server 108 and served by the web server module 224. The hosted libraries 236 may include open-source Java Script libraries, which may include JQuery, JQuery-UI, leaflet, bootstrap, and Carto-DB.

The client generates the data queries (for the tile proxy module 222). The data queries include: (i) layer queries that request layer information, from the layers data 214, for displaying the layers on the map on the client; and (ii) filter queries that request property-specific information, from the land-parcels data 212, for displaying on the map on the client. Each data query is associated with a data source. For each layer query, the data source is a non-property-specific data source in the layers data 214 (e.g., look-up data in a look-up table): accordingly, the layer query results may be referred to as results that do not have to be customised. For each filter query, the data source is the land-parcels data 212 (e.g., a table including the land parcels for the whole region, or for a selected sub-region, with a row for each land parcel). Each data query can include one of the Region IDs, selected by the client based on which region covers the map displayed on the client. Each data query also defines a rendering style (also referred to as a “theme”) that defines how the polygons of the query results are rendered in the map tiles in the query results. The style includes a line colour, a fill colour, a transparency, and/or a line thickness. The style may be defined using a standard protocol or map styling language, e.g., CartoCSS.

The layer queries include: (i) a display area definition that can include a list of required map tile IDs (based on the map area displayed by the client, according to a standard protocol, including zoom level, latitude and longitude) for the screen display area, as determined by the client; and (ii) a layer ID that represents which of the available layers has been selected, generated by the client, and which the GIS server 106 can interpret to select a corresponding predefined layer data source and a corresponding layer style when the layer query is received (i.e., the rendering style is set in the GIS server 106). The layer data sources include the layers data 214. The GIS server 106 responds to the layer query by generating one or more map tiles, using the layer data source and the layer style, to cover the defined display area in the layer query. The GIS server 106 also caches generated layer map tiles, and can serve these directly using the map tile IDs and the layer ID. For some relatively static layers, e.g., topographic layers, the map tiles can be pre-cached before any layer queries are made, so the map tiles may be rapidly provided by the GIS server 106. For example, a client can generate a layer query to just show a suburbs layer for the area on the screen of the user device 110: this layer query will include a plurality of individual requests for the map tiles in the current screen, at the current zoom level (defined based on a naming convention that includes zoom level, latitude and longitude, so that the client can determine how many tiles to fit on the screen), and the layer ID of the suburbs layer. In this example, on receipt of the layer query, the GIS server 106 looks up the suburbs layer identifier in the stored data to determine the associated data source and layer style, then generates the requested map tiles using the data source in the layers data 214 (or retrieves them pre-generated from cache), and sends them to the client in response to the layer query.

The filter queries (also referred to as “select queries” or “property queries”) include criteria for filtering or selecting the land parcels in the processed GIS data, e.g., including filters defined by structured query language (SQL) queries. The filter queries define the one or more selection criteria from the user that are used by the GIS server 106 to select ones of the land parcels for transmission of relevant information back to the client via the application server 108. The client generates each filter query to refer to the land-parcels data 212 as the data source (e.g., the processed table), and to include a rendering style (including a line colour, and a fill colour) for the polygons corresponding to the land parcels with property information that match the criteria. The GIS server 106 selects a subset of the land parcels (or rows) based on each data query, e.g., using standard SQL processing. The GIS server 106 then extracts or selects the geometry for each selected land parcel in the subset (i.e., a polygon for each property). The GIS server 106 then determines the rendering style for each polygon from the filter query, then renders each property polygon based on the geometry shape and the rendering style. The GIS server 106 thus returns results of the filter queries to the application server 108 in the form of results data representing the information about the selected land parcels in the processed GIS data. The returned results data represent descriptive text, numerical values, process map visualisations in the form of map tiles, and a grid for detecting user-interface selections of points on the map (e.g., mouse clicks). The filter queries are validated by the application server 108 (the tile proxy module 222) before transmission to the GIS server 106 to allow only preselected criteria and SQL, which can provide security against undesirable access by the client.

Each of the pre-processing computer system 102, the GIS server 106, the application server 108, and the user device 110 includes one or more computer processors, which may be referred to as data processors, including microchip computers, and random access memory (RAM) modules, and other computer-readable storage media, that store computer-readable instructions that, when executed, allow these devices to perform the functions and operations described herein. These systems and devices include non-volatile and non-transitory (e.g., hard disk) computer-readable storage with machine-readable instructions for controlling the respective computer processors to perform the methods and processes described herein, and to embody the modules and software components described herein. These systems and devices include external computer interfaces for communicating with each other, including over an electronic network including the internet. The boundaries between the modules and the software components can be altered, and some embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), reduced instruction set computer (RISC), firmware programmed into programmable or erasable/programmable devices, the configuration of a field-programmable gate array (FPGA), the design of a gate array or full-custom application-specific integrated circuit (ASIC). The data generation, data storage and data communications operations relate to digital data operations. The digital data may include electronic data defined by logic circuits—which may include binary logic circuits—represented by electronic quantities, which may include voltage, current and/or resistance.

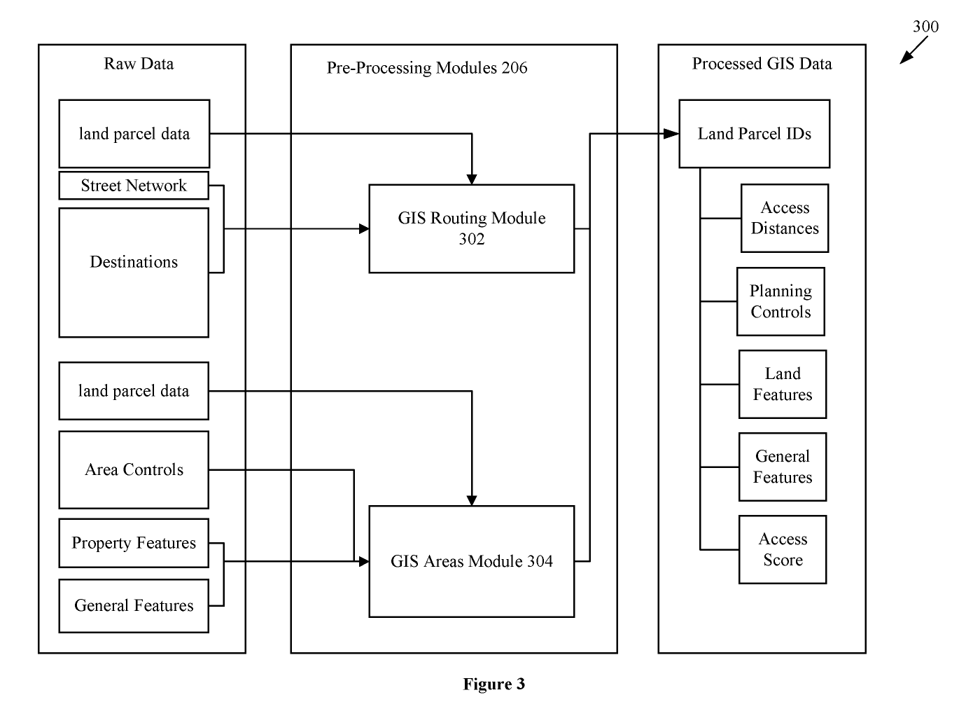

As shown in FIG. 3, the pre-processing module 206 includes a routing submodule 302, and an areas-processing submodule 304 (also referred to as a “GIS Areas Module 304”).

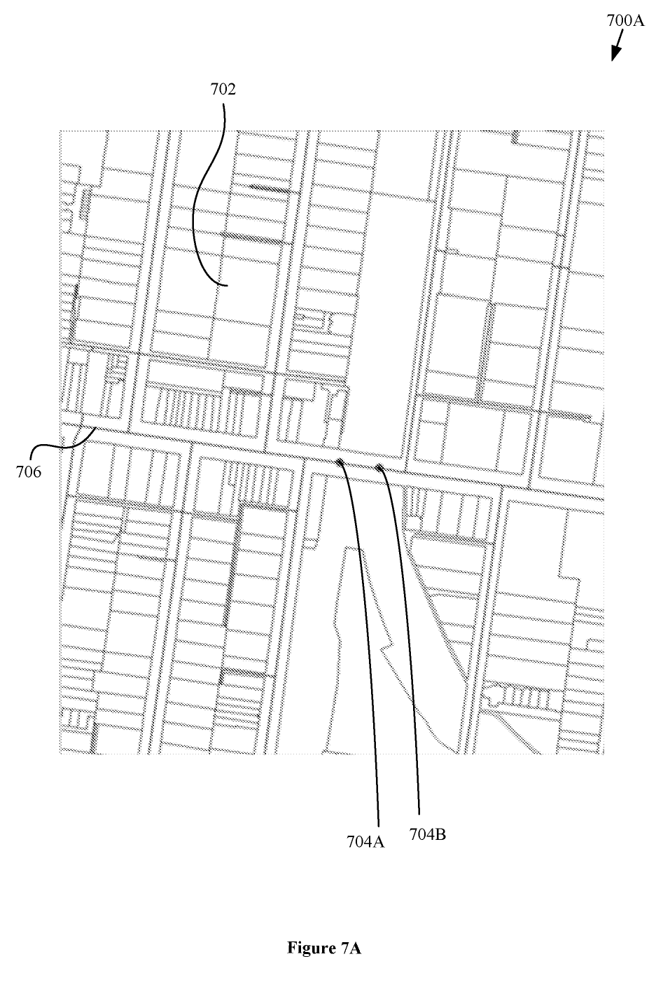

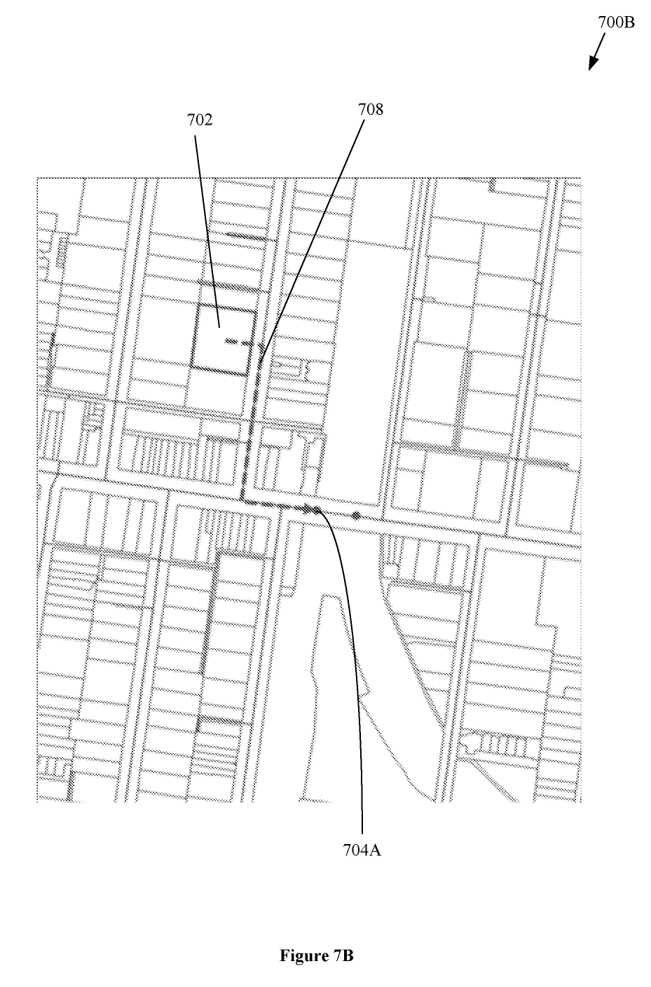

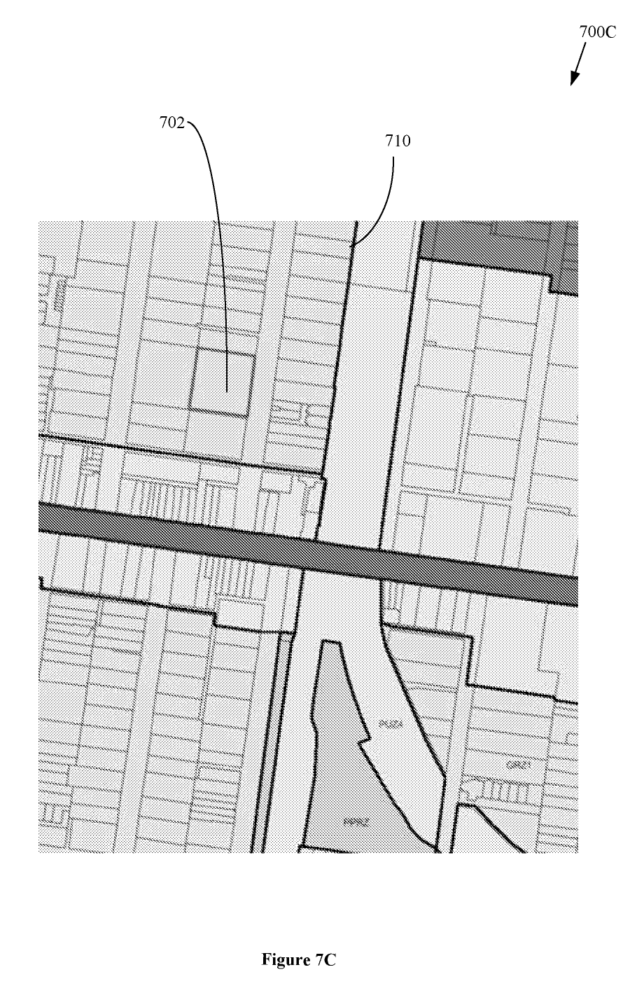

The routing submodule 302 accesses the raw GIS data representing: land parcel data (containing land parcels with individual land parcel identifiers); coordinates of a street network corresponding to the geographical locations of the land parcels; and coordinates of the destinations, including locations and/or access points for the following destination types: train stations, tram stops, bus stops, shops, shopping precincts, open spaces, schools, colleges, universities and business districts, and a foreshore (e.g., beach front, or river edge). The routing submodule 302 calculates a distance from each land parcel to each of the closest one of each type of the destinations following the street network (or directly for the foreshore), and embeds these distances into the data record for each land parcel. For example, for a land parcel 702, as shown in FIG. 7A, there may be two access points for the train station 704A, 704B, defined by coordinates in train station data, and a street network 706 defined by street coordinates, all in the raw GIS data. The routing submodule 302 accesses or determines an access coordinate for the land parcel, which may be a centroid of the land parcel (which may be predefined in the raw GIS data), or a coordinate of the land parcel adjacent the street network. The routing submodule 302 then determines a shortest path or route along the street network from the access coordinate, defining location of the land parcel, to a closest coordinate defining the destination of each type. For example, the routing submodule 302 may determine a route from the centroid of the land parcel 702 to the closest train destination 7A along the calculated route 708, as shown in FIG. 7B. The routing submodule 302 then determines the distance of this calculated route, and enters or saves that distance value in the land-parcels data 212 identified by that land parcel identifier (ID). For example, the determined distances may be generated in a table indexed by the land parcels IDs, and distances may be added to the table of processed land parcels by matching the land parcel IDs, then inserting the nearest distances into the respective rows for the matching land parcel IDs. Each land parcel can then have corresponding row in the data table, and the distance to the nearest destination, for each type of destination, being updated into a different column along the row for that land parcel ID. The routing submodule 302 may be implemented using commercially available software with a commercially available transport routing plugin. By operation of the routing submodule 302, the land-parcels data 212 include the plurality of accessibility distances for each land parcel (represented as decimal values), including a distance to nearest train station, a distance to nearest tram stop, a distance to nearest bus stop, a distance to nearest shop or shopping precinct, a distance to nearest open space (e.g., a park or reserve), a distance to nearest school or college (including primary school and secondary school, each associated with a school ID), a distance to nearest university, and a distance to nearest business district (which may be a specific business district such as a central business district of a metropolitan area), and a direct distance to the nearest foreshore.

The routing submodule 302 generates a weighted property accessibility score (which may be referred to as an “Access Score” or “access score value”) based on a combination of a plurality of the accessibility distance values, wherein each of the different accessibility values is weighted by a different pre-selected weighting based on the associated destination type. The calculated property accessibility score may be referred to as an “access rating”. The access rating represents the overall accessibility of a land parcel based on a combined and weighted rating of each parcel based on its accessibility to train stations, bus stops, smart bus stops, tram stops, open space, retail and schools. In order to calculate the rating, two functions are implemented in the routing submodule 302. The first function assigns each land parcel in the database with a weighted Access Score. The second function assigns each land parcel an overall Access Rating that is benchmarked against the Access Scores of all land parcels. The function to calculate the Access Score may use the following relationship:

Access Score=(Maximum(0,5−Train))*1+(Maximum(0,3−Bus))*0.33+(Maximum(0,3−Smart_bus))*0.66+(Maximum(0,3−Tram))*0.66+(Maximum(0,3−OpenSpace))*0.33+(Maximum(0,5−Retail))*1+(Maximum(0,3−Schools))*0.33.

The first part of the function “(Maximum(0,5−Train))” returns a value based on the distance from a train station, in particular 5 km minus the value of the distance from a train station for each land parcel. The distance 5 km may be selected as the maximum distance from a train station as parcels beyond that distance are considered to have poor accessibility to a station, so any land parcel which is further than 5 km from a train station will return a value of 0 (the ‘Maximum’ function returns 0 ‘5−Train’ is less than 0). In embodiments, the maximum 5 km distance may be selected to be a different maximum, which may be 3 km, 4 km, 6 km, 7 km or 8 km. The second part of the function ‘*1’ gives the score a weighting because some of the destinations are considered to be more important for overall accessibility than others. The train weighting above is “1” (a 100% weighting), although in other embodiments the train weighting may have a different value. The bus weighting (shown above with a 33% weighting) may be less than the train weighting. The smart bus weighting may be 66%. The tram weighting may be 66%, the open space weighting 33%, the retail weighting 100%, and the schools weighting 33%. The maximum distance for tram stops, bus stops, smart bus stops, open spaces and schools may be 3 km. The maximum distance to retail may be 5 km.

Once the Access Score is embedded into (or associated with) each land parcel (e.g., added to each row of the table in the land-parcels data 212), the maximum Access Score value of the entire database is calculated, and associated with the land parcel ID in the land-parcels data 212. This score is considered to be the maximum benchmark for accessibility and would give a property a 100% rating. The Access Rating value is then generated for each land parcel by normalising that land parcel's Access Score value by the maximum Access Score value, and associated with the land parcel ID in the land-parcels data 212.

The data representing the publicly accessible destinations may define areas of the destinations, but not necessarily coordinates where these areas intersect with the street map. The train stop data may require processing to define the closest points on the road network for each train stop. Similarly, the retail data may require processing to define the closest points on the road network for each shop and/or shopping precinct. Accordingly, the input module 202 and/or the pre-processing module 206 may use the street data and the coordinates of the destinations to determine accessible points for the destinations. This step of assigning access points to the destinations may be performed by the input module 202 and/or the pre-processing module 206, and may be automated, or may require one or more manual sub-steps, depending on the destination type. Thus, the pre-processing computer system 102 may be configured to determine access point coordinates for the publicly accessible destinations, based on the coordinates of the destinations and on street map data, and to generate the proximity data using the access point coordinates for the destinations.

The areas-processing submodule 304 accesses the land parcel data, and the region data in the raw GIS data. The raw region data are publicly accessible and represent region or area definitions (based on coordinates, polylines, or polygons) representing area features or attributes, including planning controls, property features and general area features. The planning controls data represent coordinates or polygons with codes or values defining land use zones, major road frontages, heritage controls, allowable building heights, minimum sub-division lot size, and other planning overlays. The land use zones may include a farming zone, a green-wedge zone, a low-density residential zone, a rural activity zone, a rural conservation zone, a rural living zone, a township zone, an industrial zone, a commercial zone, and/or a residential zone. The property features data represent coordinates, polylines and values defining laneway access points, which may be referred to as right-of-way (ROW) access, and a land slope. The general area features data represent coordinates or polygons with codes or values defining suburb identifiers, city identifiers, municipality identifiers, and property prices (e.g., median house prices). The areas-processing submodule 304 determines the coordinates of each land parcel in the land parcel data, and embeds the relevant values (including zone IDs and overlay IDs) in the data record for each land parcel by determining which of the planning controls, property features and general features have areas that overlap with the area of the land parcel. The areas-processing submodule 304 determines the land slope for each land parcel by calculating an average from raw topographic values that overlap with the property area (e.g., by averaging the slope grid of points in each land parcel geometry). The areas-processing submodule 304 determines the number of road frontages by: (i) editing the raw road casement data to remove freeways and remove intersections; and (ii) determine a number of road frontages by calculating how many remaining road casements are adjacent to each land parcel geometry.

If the zones and overlays are not defined in the raw data with same accuracy as the property geometries, a land parcel may overlap by only a small amount, so the areas-processing submodule 304 records a zone ID or overlay ID in association with a land-parcel ID in the land-parcels data 212 if the geometric overlap is above a selected threshold (e.g., over 90%, or above 95%, or above 99%, or above 99.5%) in the zone.

The areas-processing submodule 304 determines the property area of each land parcel, based on the geometry coordinates or polygon of each land parcel, and this is embedded into the data record for each land parcel, together with the property polygon itself, and a longitude, a latitude, and a street address of the land parcel. The areas-processing submodule 304 also determines and embeds a maximum length of the land parcel and a maximum width of the land parcel.

The areas-processing submodule 304 accesses historical title data (representing ownership titles or lots) in the government data, and compares the title geometries with the land parcel geometries to determine a number of titles for each land parcel, and embeds this value in the land-parcels data 212.

The areas-processing submodule 304 generates the following processed data in the processed GIS data, for each land parcel: the relevant land use zone (a code or description), whether there is a major road frontage (yes or no), the relevant heritage control (a code or description), the relevant flooding control (a numerical value or a code), the allowable building-height value (a numerical value), the minimum sub-division lot size value (a numerical value), the lot area (a numerical value), whether there is laneway access (yes or no), the average land-slope value (a numerical value), the suburb identifier (a code or description), the municipality identifier (a code or description), one or more house or property price values (numerical values). The flooding control can be based on a superposition geometry by combining flood-related planning overlays and planning zones in the raw data, and selecting the land parcels that touch the combined geometry.

The areas-processing submodule 304 generates, for each land parcel, a data record representing: geometry of the land parcel (including a polygon with coordinate values); attributes of the property (including attributes in the raw data, and attributes generated by the areas-processing submodule 304, including whether the land parcel has a strata title); the property PFI (e.g., as a character or text); and the property identifier (e.g., an integer). The property Persistent Feature Identifier (PFI), which is an individual property identifier provided by the State Government, can be used for searching and identifying properties.

The areas-processing submodule 304 determines an orientation of each land parcel, based on its raw geometry, and embeds the orientation in the land parcel record. The areas-processing submodule 304 also determines a central point (i.e., a point generally in or towards the center of the land parcel, which can be the centroid) for each land parcel, based on its geometry, and uses a comparison of the central point with a latitude value (from the raw data) to determine whether the land parcel has a equator-facing back yard: i.e., a north-facing back yard (for the southern hemisphere), or a south-facing back yard (for the northern hemisphere). The latitude value can be on or towards the boundary of the geometry that is adjacent to the street, i.e., the front boundary. The latitude value can be a street address point if the raw data provides street address points towards or on the street boundary for each land parcel. Alternatively, the latitude value can be determined from an overlap of the land parcel geometry with the adjacent road casement. For example, in the southern hemisphere, the areas-processing submodule 304 can identify lots with a north yard if they have: a N-S orientation (0-30 or 160-180), and (Lat<CentroidY(obj)).

The areas-processing submodule 304 also generates the separate layers data representing the layers in the layers data 214. These separate layers include layers of any one or more of the areas in the raw region data, and in the market data. The predefined layers that are defined by an operator or designer of the system 100. Each predefined layer includes a data source, layer criteria (e.g., an SQL query), and a layer style that defines the map style (e.g., in a standard map styling language) used to generate a map from results of the layer query. The predefined layers include: location layers, including a municipalities layer, a suburbs layer, a property parcels layer; planning layers, including: a planning zones layer, a heritage and built form overlays layer, a environmental and landscape overlays layer, a land management overlays layer, a other overlays layer, a urban growth boundary layer, a approved precinct structure plans layer, an urban planning implementation plans layer; context layers, including at least a context plan layer; topography layers, including contours (1 m and 10 m) layers, a slope analysis layer, an elevation layer; real estate layers, including a median house prices layer, and a median unit prices layer; and transport route layers. The context layer is a predefined layer including a predefined combination of a plurality of layers, including: Retail Zones, Mixed Use Zones, Office Zones, Commercial Zones, Industrial Zones, Education Zones, Open Space Zones, and Transport Stops and Routes for Bus, Train and Tram. Each layer is pre-built by selecting a data source, the layer criteria and the layer style. Each layer has a unique layer identifier (ID), which is a code stored in the client and in the stored GIS data (in the GIS server 106). The client sends a selected layer ID with each layer query, and the GIS server module 220 selects the appropriate layer by matching the incoming layer ID with one of the stored layer IDs, thus identifying the corresponding portions of the layers data 214 to send.

The areas-processing submodule 304 also generates the look-up tables, including school lookup tables that associate the school IDs and school names.

The pre-processing module 206 and/or the output module 210 are configured to divide the processed geospatial data into a plurality of portions corresponding to the different sub-regions of the region represented by the land-parcels data 212. The number of sub-regions may be selected to be 2, 3, 4, 5, 6, 7, 8, 9, or 10 (or up to 20, 50, or 100), depending on the number of land parcels in the region. Each sub-region corresponds to a data set, e.g., a table stored as a TAB file, and each sub-region can thus correspond a sub-table in the processed GIS data. The data sets can be generated by the pre-processing module 206 or the output module 210 using Boolean commands to generate the sub-regions, each including different land parcels so the sub-regions are not overlapping, based on pre-selected central or centroid points for the respective sub-regions. The regional data sets are associated with sub-region IDs in the processed GIS data. The data queries include sub-region IDs that are used by the GIS server 106 to select an appropriate regional data sets for each data query. The data sets are selected to define vertical and/or horizontal boundaries between the sub-regions to reduce instances of the map display screen extent on the client overlapping more than one of the sub-regions.

### Method

The system 100 performs or executes a data-processing method for searching land parcels, the method including the steps of:
a. accessing raw geographical information system (GIS) data, including land-parcel data representing land-parcel coordinates that define a plurality of land parcels, and publicly accessible destination data representing coordinates of publicly accessible destinations;
b. processing the raw data to generate the proximity data using a distance-determination method 400, as described hereinafter;
c. processing the raw data to generate the planning data and the land-features data using a planning-control-determination method 500, as described hereinafter;
d. processing the raw data to generate the property areas data using an area-determination method 600, as described hereinafter;
e. the user controlling the user device 110 to generate a request data for the application server 108, including the access distance criteria, which may include numerical values, and ranges of numerical values, and identifying information for the one or more publicly accessible destinations associated with each distance in the access distance criteria;
f. the application server 108 receiving request data from the user device 110 representing selection criteria (including the access distance criteria) for selecting ones of the land parcels;
g. the application server 108 combining the request data with key data, and sending it to the GIS server 106;
h. the GIS server 106 authenticating the key data, performing the selection based on the criteria in the request data (which include an SQL query), including selecting the ones of the land parcels with determined distances matching the requested access distance criteria, and returning response data representing selected land parcels, and any requested additional information, to the application server 108;
i. the application server 108 removing any key data, and passing the selected land parcels, and any requested additional information, to the user device 110; and
j. the user device 110 displaying the selected land parcels, and any requested additional information (which may be as a colour profile), on a map for the user.

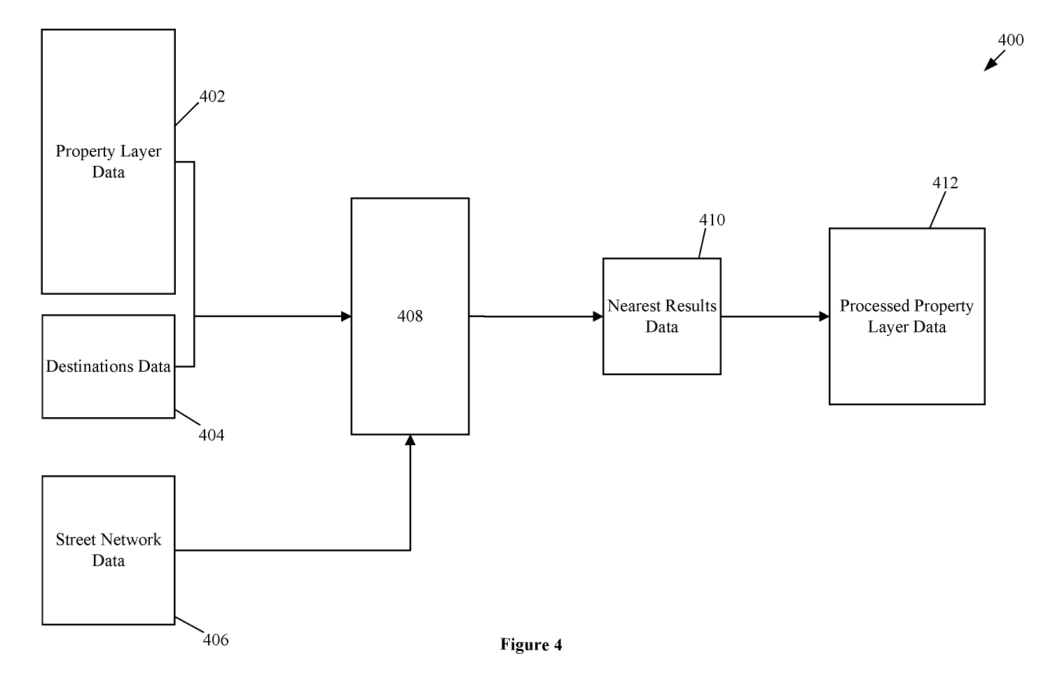

As shown in FIG. 4, the distance-determination method 400 includes the steps of:
a. accessing land parcel data, in the raw GIS database 204, that represent geometry of the land parcels in the form of polygons, including coordinates, and attributes identifying the land parcels, including an identifier (ID), and the property PFI, and transmitting the land parcel data to the routing submodule 302 (step 402);
b. accessing the destinations data, in the raw GIS database 204, representing the destinations—or destinations of one type—including the geometry of the destinations (including coordinate points), and attributes (including quasi-unique IDs) and sending the destination data to the routing submodule 302 (step 404);
c. accessing the street network data in the raw GIS database 204 including the geometry (including lines and polylines of the coordinates of the street network), and attributes (including a street class, represented by a code or integer value), in sending the street network data to the routing submodule 302 (step 406).
d. the routing submodule 302 determining a distance for each land parcel to the nearest destination of each type (e.g., the nearest train station for each land parcel), which may be referred to as determining the nearest one results for each type of destination (step 408);
e. receiving data representing the origin coordinate (as a character value), the destination coordinate (as a character value), and the distance value (as a decimal value) for each land parcel and its nearest destination of each type (step 410); and
f. storing the routing results from step 410 in the processed GIS database 208 in processed land parcel data (step 412).

The pre-processing module 206 operates on a regular and/or periodic basis to generate the pre-process GIS data. For example, the pre-processing computer system 102 may operate to upload the raw GIS data, and pre-process the data, on a daily or nightly basis, or on a monthly or weekly or monthly basis. This enables the processed data to be kept up to date, without slowing down the serving of the processed data from the GIS server 106. The input module 202 may operate to access the raw data at different intervals from the different sources. The planning data may be updated monthly. The parcels data may be updated quarterly to account for any subdivisions, or movement of the destinations (e.g., bus stops, shopping precincts).

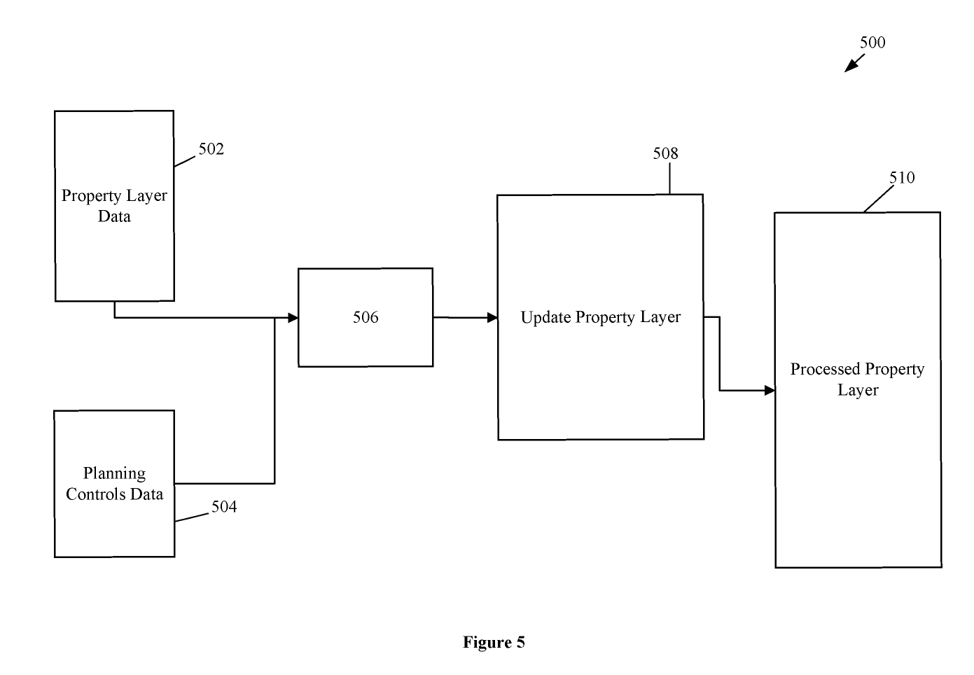

As shown in FIG. 5, the planning-control-determination method 500 includes the steps of:
a. accessing land parcel data, and transmitting it to the areas-processing submodule 304 (step 502);
b. accessing planning controls data in the raw GIS database 204, where the planning controls data include geometry of the planning zones, represented by polygons, and coordinates, and attributes data representing control codes (e.g., characters or text), and sending the planning controls data to the areas-processing submodule 304 (step 504);
c. the areas-processing submodule 304 processing the planning controls data to determine overlapping planning controls for each land parcel based on the land parcel polygon overlapping one of the planning controls (step 506);
d. the areas-processing submodule 304 updating the land parcel data to include the control codes for each overlapping and planning (step 508); and
e. storing the updated land parcel data in the processed GIS database 208 (step 510).

The land-parcels data 212 include: a zone code for representing the relevant land-use zone, a heritage code representing a heritage control, a building height code or value representing an allowable building height, a major road code indicating whether a land parcel fronts on to a major road; a minimum lot size value representing the control minimum lot size for sub-division; and a planning overlays code representing other planning overlays.

As shown in FIG. 7C, it can be determined that the polygon representing the example land parcel 702 overlaps by falling within the polygon of a zone 710, as displayed on map 700C.

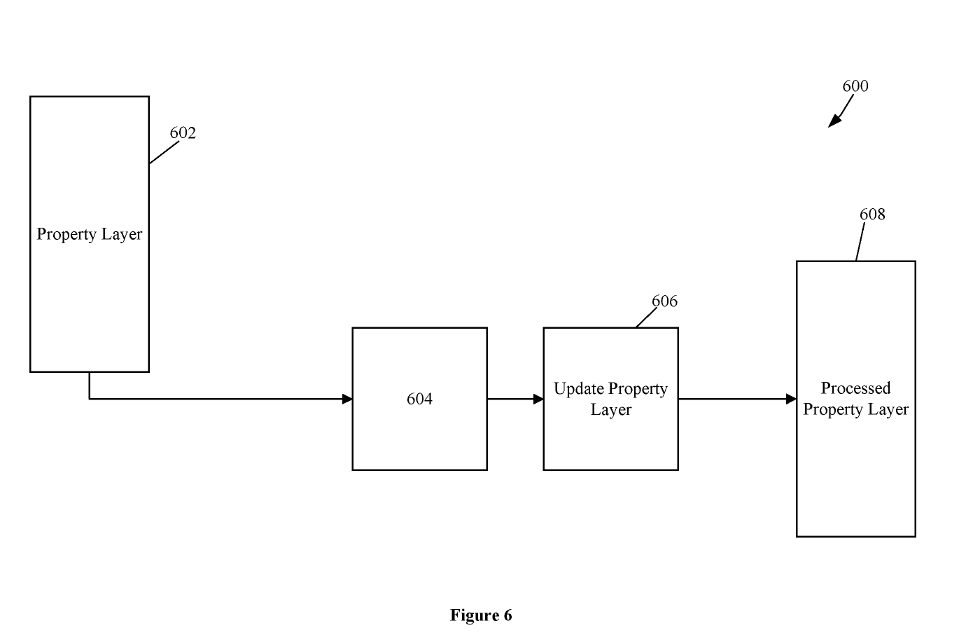

As shown in FIG. 6, the area-determination method 600 includes the steps of:
a. accessing the land parcel data, and sending it to the areas-processing submodule 304 (step 602);
b. determining the land parcel boundary coordinates from the land parcel geometry data; and determining the area of each land parcel using a mathematical function to determine the area, e.g., in square metres, to generate area data representing this determined area (step 604);
c. updating the land parcel data to include the area value for each land parcel (step 606); and
d. withdrawing the updated land parcel data, including the area data, in the processed GIS database 208 (step 608).

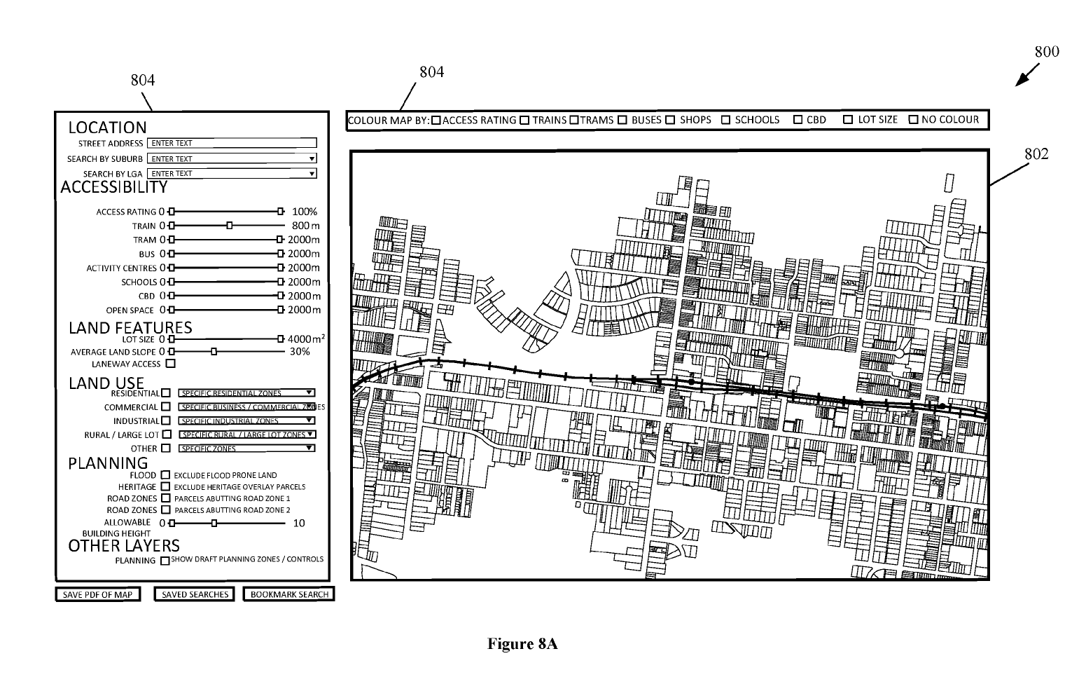

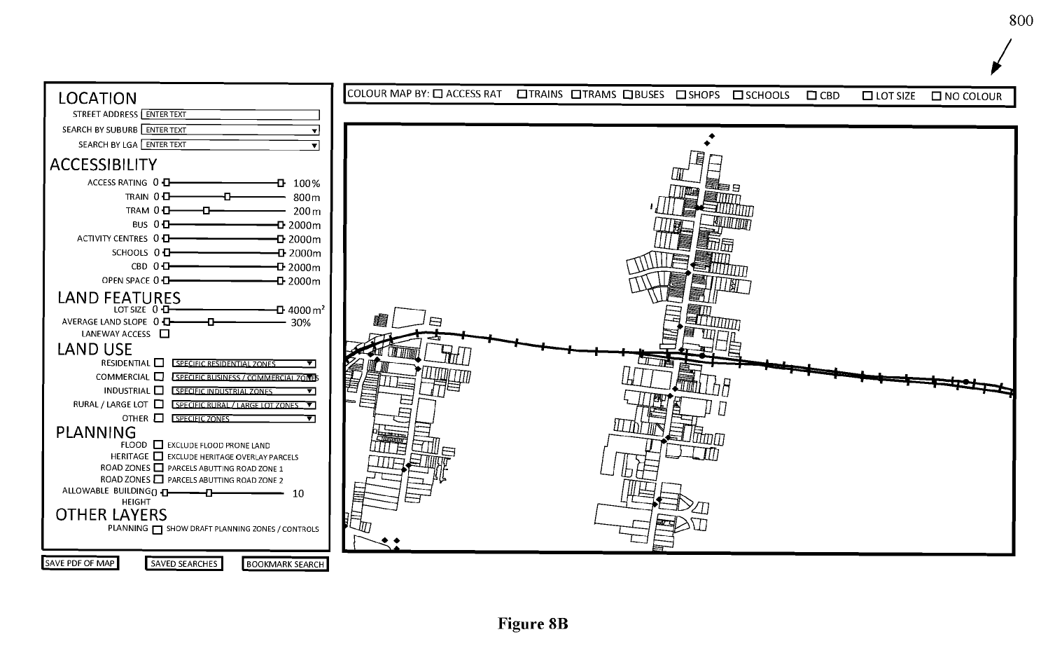

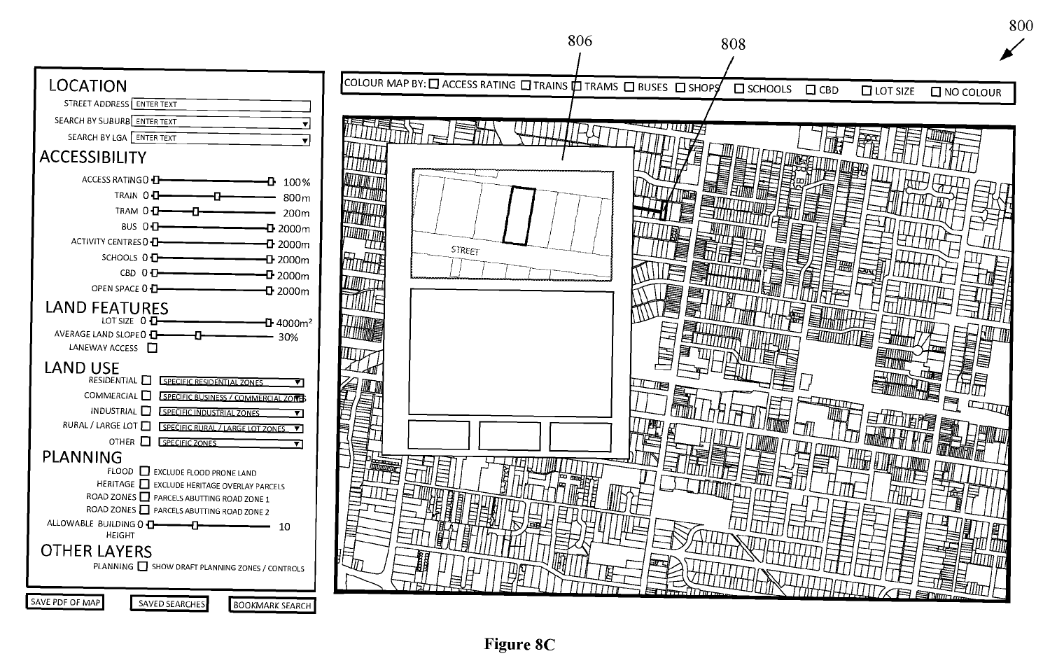

As shown in FIGS. 8A and 8B, the user interface (UI) 232 includes a map display 802 showing the land parcels as polygons on map tiles, and relevant map features, including open spaces, public transport stops, public facilities, and roads.

The UI 232 includes a plurality of user controls 804 that receive input from a user, and that generate data for the web browser 230 to generate the data queries. As shown in FIG. 8A, the controls 804 include location controls that can receive a street address (as text), a suburb identifier (as text), or a local Government authority (as text). These values are used to generate data queries to select only land parcels, represented in the GIS server database 218, with values corresponding to these control values, and the selected land parcels correspond to the land parcels displayed in the map display 802.

The controls 804 include accessibility controls, which can define a range of values, which may be based on a lower numerical limit and an upper numerical limit, for the following: the access rating, the train distance, the tram distance, the bus distance, the activity centre distance, school distance, the business district distance and the open space distance; lot size; the average land slope; and the allowable building height. These numerical or value-based controls can include graphical sliders showing a range of values represented by a line, with markers that can be moved through interaction with the user interface 232 to define the lower and upper limit for the values (and thus a range of acceptable values for the data queries). The controls 804 can include binary-input controls, including a laneway access control that can be selected to select only land parcels with laneway access. Similarly, a flood control can be selected to exclude flood prone land parcels, a heritage control can be selected to exclude heritage overlay land parcels, and road zone controls can be selected to include land parcels abutting a selected road zone (e.g., road zone 1 or road zone 2).

In an example, land parcels can be selected with a minimum value (0 metres) a maximum value of the distance to nearest train (800 metres), as shown in FIG. 8A. Additionally, land parcels may be selected with a minimum value (0 metres) and a maximum value (200 metres) to the nearest tram stop, as shown in FIG. 8B.

The controls 804 associated with accessibility, lot size, land use and planning may be referred to as the “filtering controls” because these controls generate values used to filter the land parcels by the data query. The filtering controls are used to generate a plurality of criteria that are applied simultaneously in the data queries, thus the filtered land parcels filter all of the criteria defined by the filtering controls. The criteria are used to generate SQL queries, for example in the follow form:
SELECT*FROM property layer WHERE AND overallrat>=10 AND overallrat<=80 AND Train>=0.555 AND Train<=3.185 AND zonecode IN (‘GRZ’,‘NRZ’,‘RGZ’,‘R1Z’,‘R2Z’,‘R3Z’,‘MUZ’,‘UGZ’) AND rdzone1 IN (‘RDZ1’),
where the “overallrat” refers to the Access Rating, the “Train” values are distances, the “zonecode” values are predefined zone codes, and “rdzone1” value is a predefined road type.

The controls 804 may include layer controls (or “layering controls”), which control the user interface 232 to display layers on top of the land parcels in a map display 802, including a planning control that can display the areas or polygons of the different planning layers. The layers controls generate the layer queries.

The controls 804 include colour controls that allow the land parcels to be coloured according to a selected attribute. The selectable attributes include an access rating, a distance from train stop, a distance from tram stop, a distance from bus stop, a distance from shops, a distance from schools, a distance from the central business district, and etc., as described hereinbefore. The colours applied to the land parcels are generated based on the relevant value of each land parcel for that attribute (as received from the GIS server module 220), and a colour map associating the different values with different colours or colour temperatures. Style data (which may be in a commercial format) representing the styles is stored in the application server 108. When a style is selected by the user interface 232, corresponding data is submitted from the browser 230 to the tile proxy module 222, and then submitted to the GIS server module 220 for generating the response data according to the selected style.

A user can use the user interface 232 to select an information window control for each displayed land parcel (or property), e.g., by selecting the land parcel polygon with a mouse cursor or touch screen. The client then generates a data query for that land parcel (with the property ID), and the GIS server 106 selects the processed GIS data for that land parcel—based on the property ID—for the transmission in the results data (e.g., the whole row of information in a region table or sub-region table for that land parcel). The GIS server sends the data (e.g., table row) associated with that property, and the client renders the Information Window. The user interface 232 can thus display the values and attributes of each of the selected land parcels received by the web browser, and this information may be displayed in a pop-out display 806 that is linked to the selected land parcel 808, e.g., as shown in FIG. 8C.

The pop-out display 806 may be described as an information window displayed when a property is selected. The information is extracted from the GIS server database 218 in a separate query when the land parcel is selected using the user interface 232: when the user selects (by clicking on) a parcel, relevant data are requested from the servers 108 and 106 in a data query, then the resulting response data are displayed after they are received by the web browser 230. The information window displays a summary of the site, which can be saved as a PDF, or bookmarked, and represented by data stored in the user database 226. The data extracted for pop-out display may include: the street address, the lot area, the average land slope, the calculated accessibility score, the distances to the nearest destinations/facilities, the land use zone description or code, the planning control description or code, the descriptions or codes or overlapping overlays, and the maximum building height.

The data for the pop-out display 806 may include attributes of the selected land parcel that are represented or stored in the separate layers data 214 in the GIS server database 218 but not in the land-parcels data 212. In this case, the GIS server 106 performs the processing to match the selected land parcel to the relevant overlapping overlays because, for some overlays, the relevant attributes are not added to the land parcel record in the land-parcels data 212 by the pre-processing computer system 102. Accordingly, when the pre-processing computer system 102 generates the separate overlay data representing the separate overlays, the GIS server 106 is configured to: receive a data query representing a request for an attribute of the selected land parcel; process the separate overlay data and the land-parcel data to determine an overlapping one of the separate overlays with coordinates overlapping the selected land parcel coordinates; determine the requested attribute from the overlapping overlay; and generate response data representing the requested attribute for the land parcel. The requested attribute may be a planning control zone. It may be preferable to have the GIS server 106 determine attributes from overlapping overlays in cases where only one, or a few, properties are selected (thus the data processing load on the GIS server 106 is not too great to lose the flexibility and speed of the system 100), and/or where the overlay information changes rapidly or frequently (thus the separate overlay data can be updated in the GIS server database 218 without having to pre-process all of the land parcels in the entire area again).

As shown in FIGS. 8A-8C, the user interface 232 includes controls associated with that user account, including a save map control, a save search control, a bookmark search control, and controls to access the saved searches and bookmarked searches for future. These saved searches and bookmarked searches are stored in the user database 226 for future access by the authenticated user. Every land parcel can be saved and associate with a data representing a “project”, stored in the user database 226. One user can have a plurality of associated projects. Each project includes a list of property IDs, the street addresses, and a user-supplied name or description.

The user interface 232 may include a multi-attribute control that generates filter queries with alternatives for different land-parcel properties. In contrast to the other filter controls, this for land parcels to be selected that fulfil only one of a plurality of requirements (i.e. , “OR” filtering, rather than “AND” filtering). One such control is the Transport Present control that provides a plurality of preset criteria, including: (1) nearest train stop, or nearest tram stop, less than or equal to 200 m; (2) nearest train stop, or nearest tram stop, less than or equal to 400 m; (3) nearest train stop less than or equal to 800 m, or nearest tram stop less than or equal to 400 m; (4) nearest train stop less than or equal to 800 m, or nearest tram stop or smart-bus stop less than or equal to 400 m; (5) nearest train stop less than or equal to 800 m, or nearest tram stop, smart-bus stop or sub stop less than or equal to 400 m; and (6) nearest train stop less than or equal to 1.2 km, or nearest tram stop or smart-bus stop less than or equal to 800 m, or nearest bus stop less than or equal to 400 m. The routing submodule 302 may pre-generate a multi-attribute value in the land-parcels data 212 that corresponds to one of the preset criteria, e.g., a transport rank value that includes (1) to (6) corresponding to the 6 preset criteria described directly hereinbefore, and a seventh null value if outside all of the preset criteria.

### Example

Example land-parcels data 212 may represent the following columns and exemplary values:
a. a quasi-unique ID for the GIS server=261;
b. geometry=25D96B186240B07273B5C etc.;
c. a unique government property ID (PFI)=221558290;
d. a unique government property ID (UFI) 485570067;
e. a municipality=WYNDHAM;
f. a suburb=POINT COOK;
g. a distance to the nearest primary school=2.62 km;
h. a unique external primary school ID=523;
i. a distance to the nearest secondary school=3.35 km;
j. a unique external secondary school ID=583;
k. a distance to the closest school (either primary or secondary)=2.62 km;
l. zone IDs of zones that intersect the land parcel (also referred to as a “property”)=GRZ1, UGZ1;
m. overlay IDs of overlays that intersect the property=DPO2, DCPO8;
n. a longitude of the property=100.764581;
o. a latitude of the property=100.894293;
p. a street address of the property 100 GREG NORMAN DRIVE POINT COOK VIC 3030;
q. a transport ranking (of 1 to 7, where 1 is best)=7;
r. a transport rating (or access rating), or access score, as a score=6.6611;
s. the transport rating, or access score, as %=39.3%;
t. a property area=637538.2 square meters;
u. a street distance to the nearest metro train station (i.e., electrified rail station)=4.731 km;
v. a street distance to the nearest train station (of any type, i.e., electrified and non-electrified rail stations)=4.29 km;
w. a street distance to the nearest bus stop=1.32 km;
x. a street distance to the nearest smart bus stop=9.78 km;
y. a street distance to the nearest tram stop=19.18 km;
z. a street distance to the nearest open space=0.85 km;
aa. a street distance to the nearest retail area=0.26 km;
bb. a street distance to the nearest retail plan (e.g., a planned retail centre)=3.84 km;
cc. a street distance to the nearest central business district (i.e., distance to the nearest point of a predefined CBD geometry)=24.16 km;
dd. a direct distance to the nearest foreshore=3.228 km;
ee. an average slope of property=0.5%;
ff. maximum length of property=1377.58 m;
gg. maximum width of property=1072.24 m;
hh. a number of parcels or lots in each property (i.e., based on the geometry of the land parcels in the property data, and the geometry of the titles (or lots) in the historical titles data)=9;
ii. number of road frontages (i.e., the number of road casements, excluding intersections)=10;
jj. north facing backyard (TRUE or FALSE)=TRUE;
kk. orientation (degrees, 0 to 180)=7.2;
ll. property strata (TRUE or FALSE)=TRUE;
mm. part of a flood zone (TRUE or FALSE)=FALSE;
nn. first road zone (i.e., the road zone of a first adjacent road)=RDZ1; and
oo. second road zone (i.e., the road zone of a second adjacent road, if there is one)=RDZ1.

### Interpretation

Many modifications will be apparent to those skilled in the art without departing from the scope of the present invention as hereinbefore described with reference to the accompanying drawings.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### RELATED APPLICATIONS

The present application claims Convention priority from Australian Provisional Patent Application No. 2014904048, filed 10 Oct. 2014, the specification of which, as originally filed, is hereby incorporated by reference in its entirety herein.

1. A system including:
a computer system configured to:
access geographical information system (GIS) data, including land-parcel data defining a plurality of land parcels, and destination data representing locations of publicly accessible destinations, and
process the GIS data to generate proximity data by determining distances between each land parcel and the publicly accessible destinations, and representing the determined distances by the proximity data; and
at least one server configured to:
receive request data representing one or more criteria including a requested distance for selecting ones of the land parcels, and
generate response data representing ones of the land parcels with ones of the determined distances in the proximity data matching the criteria.

2. The system of claim 1, wherein the computer system is configured to determine a closest one of each destination type to each land parcel in the publicly accessible destinations, and to generate the proximity data using the closest destination of each destination type.

3. (canceled)

4. The system of claim 1, wherein the computer system is configured to:
access street data representing coordinates of a street network; and
determine the distances between the land parcels and the publicly accessible destinations by determining routes between the land parcels and the publicly accessible destinations along the street network, and
wherein the computer system is configured to determine the distances by determining the shortest routes between the land parcels and the publicly accessible destinations along the street network.

5. (canceled)

6. The system of claim 1, wherein the computer system is configured to determine the distances using the land-parcel coordinates wherein the land-parcel coordinates represent respective centroids of the land parcels, or respective street-frontage coordinates of the land parcels, wherein the street-frontage coordinates are determined from road casement geometry without intersections.

7. The system of claim 1, wherein the computer system is configured to determine access point coordinates for the publicly accessible destinations, based on the coordinates of the destinations overlapping with street map data, and to generate the proximity data using the access point coordinates for the destinations.

8. (canceled)

9. The system of claim 1, wherein the computer system is configured to generate a weighted accessibility score, represented by the proximity data, based on a combination of a plurality of the determined distances,
wherein each of the determined distances is weighted by a different pre-selected weighting based on the associated destination type, and
wherein the computer system is configured to generate an access rating value for each land parcel by normalising each land parcel's weighted accessibility score to a maximum one of the weighted accessibility scores of the land parcels.

10. The system of claim 1, wherein the at least one server is configured to generate the response data representing map tiles with only the matching ones of the land parcels.

11. The system of claim 1, wherein the computer system is configured to generate separate layer data representing separate layers for display with the land parcels, and
wherein the at least one server is configured to:
receive request data representing a request for one of the separate layers; and
generate response data representing the selected separate layer for display with the land parcels.

12. The system of claim 1, wherein the computer system is configured to generate separate layer data representing separate layers, and
wherein the at least one server is configured to:
receive request data representing a request for an attribute of one of the land parcels;
process the separate layer data and the land-parcel data to determine an overlapping one of the separate layers with coordinates overlapping the land parcel coordinates;
determine the requested attribute from the overlapping layer; and
generate response data representing the requested attribute for the land parcel.

13. The system of claim 1, wherein the computer system is configured to process the raw GIS data to generate area data representing an area of each land parcel using the land-parcel coordinates, and to store the area in association with an identifier (ID) of each land parcel.

14. (canceled)

15. (canceled)

16. The system of claim 1, wherein the at least one server includes:
an application server configured to receive the request data from a client on a user device, and to send the response data to the client; and
a GIS server configured to communicate with the application server, to access the proximity data, and to generate the response data,
wherein the application server stores and uses key data representing an access key to authenticate communication with the GIS server, and wherein the client does access or use the key data, and
wherein the application server authenticates communication with the client based on user credentials.

17. (canceled)

18. (canceled)

19. The system of claim 1, including a user interface (UI) having controls that generate the request data,
wherein the UI includes filtering controls to generate request data that select ones of the land parcels based on attributes of the land-parcel records in the processed GIS data, and
wherein the UI includes layer controls to generate request data that select one or more of the separate layers.

20. A method, including the steps of:
accessing geographical information system (GIS) data, including land-parcel data defining a plurality of land parcels, and destination data representing locations of publicly accessible destinations;
processing the GIS data to generate proximity data by determining distances between each land parcel and the publicly accessible destinations, and representing the determined distances by the proximity data;
receiving request data representing one or more criteria including a requested distance for selecting ones of the land parcels; and
generating response data representing ones of the land parcels with ones of the determined distances in the proximity data matching the criteria.

21. (canceled)

22. The method of claim 20, including the steps of:
determining a closest one of each destination type to each land parcel in the publicly accessible destinations, and generating the proximity data using the closest destination of each destination type accessing street data representing coordinates of a street network;
determining the distances between the land parcels and the publicly accessible destinations by determining routes between the land parcels and the publicly accessible destinations along the street network; and
determining the distances by determining the shortest routes between the land parcels and the publicly accessible destinations along the street network.

23. (canceled)

24. The method of claim 20, including the step of determining the distances using the land-parcel coordinates.

25. (canceled)

26. The method of claim 20, including the steps of:
determining access point coordinates for the publicly accessible destinations, based on the coordinates of the destinations overlapping with street map data; and
generating the proximity data using the access point coordinates for the destinations.

27. (canceled)

28. (canceled)

29. The method of claim 20, including the step of generating the response data representing map tiles with only the matching ones of the land parcels.

30. (canceled)

31. The method of claim 20, including the steps of:
generating separate layer data representing separate layers;
receiving request data representing a request for an attribute of one of the land parcels;
processing the separate layer data and the land-parcel data to determine an overlapping one of the separate layers with coordinates overlapping the land parcel coordinates;
determining the requested attribute from the overlapping layer; and
generating response data representing the requested attribute for the land parcel.

32. (canceled)

33. (canceled)

34. The method of claim 20, including the steps of:
an application server receiving the request data from a client on a user device, and sending the request data to a GIS server;
the GIS server accessing the proximity data, generating the response data, and sending the response data to the application server;
the application server sending the response data to the client; and
the application server storing and using key data representing an access key to send the request data to the GIS server.

35. (canceled)

36. (canceled)

37. The method of claim 20, including the steps of:
user interface (UI) controls generating the request data; and
the UI generating request data that select ones of the land parcels based on attributes of the land-parcel records in the processed GIS data.

38. (canceled)

39. (canceled)

40. (canceled)

41. (canceled)

42. (canceled)

43. (canceled)

44. (canceled)

45. Computer-readable storage with machine-readable instructions for controlling one or more computer processors to perform the method of claim 20.
